(19) United States
(12) Patent Application Publication
(10) Pub. No.: US 2008/0074352 A1
(43) Pub. Date: Mar. 27, 2008

(54) METHOD OF DRIVING PLASMA DISPLAY PANEL AND PLASMA DISPLAY APPARATUS DRIVEN BY THE METHOD

(76) Inventors: Jae-Kwang Lim, Suwon-si (KR); Jung-Soo An, Suwon-si (KR)

Correspondence Address: CHRISTIE, PARKER & HALE, LLP, PO BOX 7068, PASADENA, CA, 91109-7068, US

(21) Appl. No.: 11/687,596

(22) Filed: Mar. 16, 2007

(30) Foreign Application Priority Data
Sep. 26, 2006 (KR) 10-2006-0093675

(51) Int. Cl. G09G 3/28

(52) U.S. Cl. 345/60

(57) ABSTRACT

A method for driving a plasma display panel and a plasma display panel driven by the method. Discharge cells are formed where address electrodes cross over parallel pairs of sustain electrode. The panel is driven during frames. A unit frame in a display period includes a plurality of subfields each having a grey scale weight value to generate a time division grey scale. Each of the subfields includes a reset period, an address period, and a sustain discharge period. The reset period may be a main reset period, during which all of the discharge cells are initialized, or an auxiliary reset period, during which only discharge cells selected in a preceding subfield are initialized. During the auxiliary reset period, an erase pulse is applied to the address electrodes.

### CROSS-REFERENCE TO RELATED PATENT APPLICATION

This application claims priority to and the benefit of Korean Patent Application No. 10-2006-0093675, filed on Sep. 26, 2006, in the Korean Intellectual Property Office, the entire content of which is incorporated herein by reference.

### BACKGROUND OF THE INVENTION

1. Field of the Invention

The present invention relates to a method of driving a plasma display panel and a plasma display apparatus driven by the method, and more particularly, a method of driving a plasma display panel that includes an effective reset discharge and a plasma display apparatus driven by the method.

2. Description of the Related Art

Plasma display panels display an image using visible light emitted from a phosphor material. The phosphor material is excited by ultraviolet rays generated when a discharge occurs in an inert mixed gas contained in the panel. The plasma display panel receives attention due to its ease of manufacturing in a large scale. Plasma display panels are divided into direct current type plasma display panels and alternating current type plasma display panels according to the type of driving voltage. Due to a long delay of discharge starting time in the direct current type plasma display panels, extensive research on the alternating current type plasma display panels is being conducted.

An example of the alternating current type plasma display panel is a three-electrode alternating current surface discharge type plasma display panel that includes three electrodes and is driven by an alternating current. The three-electrode alternating current surface discharge type plasma display panel is thin and lightweight and can provide a wide image because it is formed of a multi-layered plate.

A plasma display panel includes a plurality of display cells in regions where sustain electrodes and address electrodes cross over each other. Each of the display cells consists of three discharge cells (red, green, and blue in color), and grey scale of an image can be displayed by controlling the discharge state of each of the discharge cells.

In order to display the 256 grey scales of the plasma display panel, a unit frame that is used for driving the plasma display panel is divided into eight subfields having different numbers of light emissions. That is, in order to display an image using 256 grey scales, a unit frame period (16.67 ms) corresponding to 60 Hz is divided into eight subfields. Each of the subfields includes a reset period, an address period, and a sustain discharge period in order to drive the plasma display panel.

FIG. 1 is a timing diagram for explaining a conventional method of driving a plasma display panel.

A first subfield CSF₁ of a unit frame includes a first reset period CPR₁, a first address period CPA₁, and a first sustain discharge period CPS₁. A second subfield CSF₂ occurs after the first subfield CSF₁, and includes a second reset period CPR₂, a second address period CPA₂, and a second sustain discharge period CPS₂.

During the first reset period CPR₁ of the first subfield CSF₁, all of the discharge cells are initialized. During the first address period CPA₁, a scan pulse is sequentially applied to scan electrodes Y, and discharge cells that are to be used for generating the image are selected by applying a data pulse synchronized with the scan pulse to address electrodes A corresponding to the discharge cells that are to be used. During the first sustain discharge period CPS₁ that follows the first address period CPA₁, a sustain pulse is applied to sustain electrodes X and the scan electrodes Y to cause sustain discharge only in the discharge cells that are selected for forming the image. Thus, an image formed during the first subfield CSF₁ is generated by only the discharge cells that are selected for forming the image.

Operations of the second subfield CSF₂ are performed following the first subfield CSF1. After the sustain discharge in the first subfield CSF₁ is generated and during the second reset period CPR₂, reset discharge is generated only in the discharge cells that were selected for discharge during the first subfield CSF₁. During the second reset period CPR₂, the reset discharge can be performed by applying signals having the same waveforms as applied during the first reset period CPR₁, or alternatively, by applying waveforms different from the waveforms of the first reset period CPR₁. During the second reset period CPR₂, that is depicted in FIG. 1, a signal having a failing ramp waveform voltage that reaches a falling minimum voltage Vnf by falling from a sustain discharge voltage Vs with a predetermined falling slope is applied to the scan electrodes Y. A biasing voltage Vb is applied to the sustain electrodes X when the falling ramp waveform voltage is being applied to the scan electrodes Y. Accordingly, during the second reset period CPR₂, wall charges that accumulated on the sustain electrodes X and the scan electrodes Y during the first sustain discharge period CPS₁ can be erased to some degree due to the reset discharge generated between the sustain electrodes X and the scan electrodes Y by the falling ramp voltage waveform. However, wall charges on the address electrodes A are not readily erased since a ground voltage Vg is applied to the address electrodes A. The wall charges accumulated on the address electrodes A during the first sustain discharge period CPS₁ have a positive polarity. Positive polarity wall charges can cause damage to a phosphor material and result in reducing the lifetime of the plasma display panel. In a more severe case, the wall charges accumulated on the address electrodes A during the first sustain discharge period CPS₁ can cause a latent image by generating misdischarge in an off cell, thereby reducing the reliability of the plasma display panel.

### SUMMARY OF THE INVENTION

Exemplary embodiments of the present invention provide a method of driving a plasma display panel that can increase reliability of the plasma display panel by improving latent image problems and can increase the lifetime of the plasma display panel by preventing the degradation of phosphor material. Exemplary embodiments of the present invention further provide a plasma display panel that is driven by the method provided by the embodiments of the invention.

According to exemplary embodiments of the present invention, discharge cells are formed at regions where address electrodes cross sustain electrode pairs. The sustain electrode pairs include which X electrodes and Y electrodes that are located in parallel. A unit frame in a display period includes a plurality of subfields each having a grey scale weight value to display a time division grey scale. Each of the subfields includes a reset period, an address period, and a sustain discharge period. The reset period is either a main reset period, during which all of the discharge cells are initialized, or an auxiliary reset period during which the discharge cells selected in a preceding subfield are initialized. During the auxiliary reset period, an erase pulse is applied to the address electrodes.

A data pulse may be applied to the address electrodes during the address period. The erase pulse and the data pulse may be pulses that rise to an identical voltage. The erase pulse and the data pulse may each include a reference voltage and a first voltage greater than the reference voltage. The reference voltage may be predetermined.

A reference voltage may be applied to the address electrodes during the main reset period. During the main reset period, a main reset pulse may be applied to the Y electrodes. The main reset pulse may rise from a second voltage which is higher than the reference voltage to a third voltage which is lower than the reference voltage and then fall. During the main reset period, a main reset pulse may be applied to the Y electrodes. The main reset pulse may rise from the second voltage to a fourth voltage which is higher than the second voltage and fall to the third voltage after the fourth voltage.

During the auxiliary reset period, an auxiliary reset pulse that rises from a reference voltage to a second voltage higher than the reference voltage and then falls to a third voltage lower than the reference voltage may be applied to the Y electrodes. During the auxiliary reset period, the erase pulse may be applied to the address electrodes prior to applying the auxiliary reset pulse to the Y electrodes.

One embodiment of the present invention provides a method of enhancing erasure of wall charges remaining after an address discharge on address electrodes of a three-electrode surface discharge type plasma display panel. The plasma display panel includes discharge cells formed at crossings of the address electrodes over parallel pairs of sustain electrodes and scan electrodes. The plasma display panel is driven during unit frames. Each unit frame is divided into a plurality of subfields. Each subfield includes a reset period, the address period, and a sustain discharge period. The reset period of each subfield is either a main reset period for resetting all the discharge cells or an auxiliary reset period for resetting a group of discharge cells that have undergone the address discharge during the address period of a prior subfield. The method includes applying an erase pulse to the address electrodes during the auxiliary reset period. The erase pulse is applied at a beginning of the auxiliary reset period.

According to exemplary embodiments of the present invention, a plasma display apparatus includes a first substrate and a second substrate that are separated from each other and face each other, X electrodes and Y electrodes extending across discharge cells that are discharge spaces located between the first and second substrates, address electrodes extending across the discharge cells crossing over the X electrodes and the Y electrodes at the discharge cells, and a panel driver that applies driving signals to the X electrodes, the Y electrodes, and the address electrodes. The driving signal includes a unit frame that in turn includes a plurality of subfields for displaying a time division grey scale. Each of the subfields includes a reset period, an address period, and a sustain discharge period. The panel driver may include a main reset driver that initializes the entire discharge cells during the reset period and an auxiliary reset driver that initializes discharge cells selected in a preceding subfield. The auxiliary reset driver applies an erase pulse to the address electrodes during the reset period.

The auxiliary reset driver may further apply a data pulse to the address electrodes during the address period. The erase pulse and the data pulse may each include a reference voltage and a first voltage higher than the reference voltage.

### BRIEF DESCRIPTION OF THE DRAWINGS

FIG. 1 is a timing diagram of a conventional method of driving a plasma display panel.

FIG. 2 is a perspective view illustrating a structure of a plasma display panel according to an embodiment of the present invention.

FIG. 3 is a block diagram of a plasma display apparatus according to an embodiment of the present invention.

FIG. 4 is a timing diagram illustrating a method of driving a plasma display panel according to an embodiment of the present invention, in which a unit frame is divided into a plurality of subfields.

FIG. 5 is a timing diagram illustrating a method of driving the plasma display panel of FIG. 2, according to another embodiment of the present invention.

FIG. 6, FIG. 7 and FIG. 8 are photographs of latent images generated by the plasma display panel of FIG. 2.

### DETAILED DESCRIPTION OF THE INVENTION

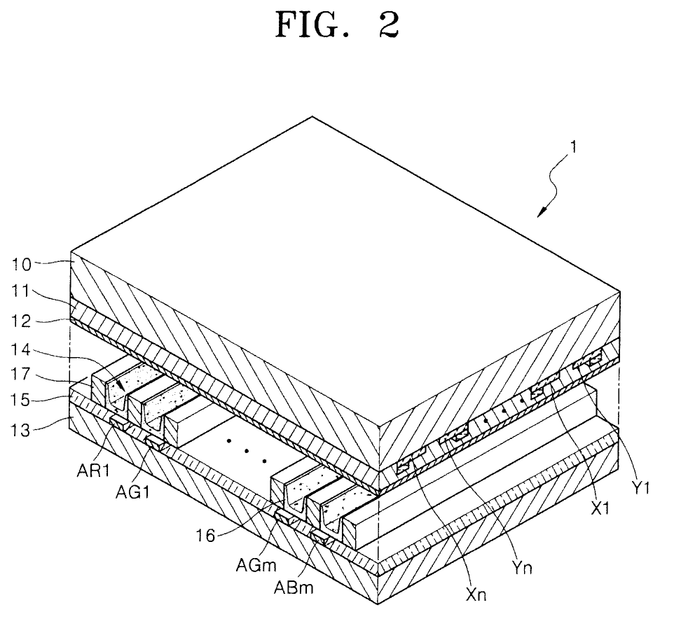

FIG. 2 is a perspective view illustrating the structure of a three-electrode surface discharge type plasma display panel 1 according to an embodiment of the present invention.

Address electrode lines A_{R1}, A_{G1}, A_{B1} through A_{Rm}, A_{Gm}, A_{Bm}, upper and lower dielectric layers 11, 15, Y electrode lines Y₁ through Yₙ, X electrode lines X₁ through Xₙ, a phosphor layer 16, barrier ribs 17, and an MgO layer 12 that acts as a passivation layer are formed between front and rear glass substrates 10, 13 of the plasma display panel 1.

The address electrode lines A_{R1}, A_{G1}, A_{B1} through A_{Rm}, A_{Gm}, A_{Bm} (or in brief A_{R1} through A_{Bm}) are formed on a front surface of the rear glass substrate 13. The address electrode lines may be formed according to a predetermined pattern. The lower dielectric layer 15 is formed on the rear glass substrate 13 and is coated over the address electrode lines A_{R1} through A_{Bm}. The barrier ribs 17 are formed in parallel to the address electrode lines A_{R1} through A_{Bm} on a front surface of the lower dielectric layer 15. The barrier ribs 17 define a discharge space for discharge cells 14 and prevent optical cross-talk between the discharge cells 14. The phosphor layer 16 is formed on inner surfaces of spaces formed between the barrier ribs 17 and the lower dielectric layer 15.

The X electrode lines X₁ through Xₙ and the Y electrode lines Y₁ through Yₙ are formed on a rear surface of the front glass substrate 10 perpendicularly crossing the direction of address electrode lines A_{R1} through A_{Bm}. The cross over points define corresponding discharge cells 14. The X electrode lines X₁ through Xₙ and the Y electrode lines Y₁ through Yₙ are each formed by combining a transparent electrode line formed of a transparent conductive material such as indium tin oxide (ITO) and a metal electrode line to increase conductivity. In each of the discharge cells 14, the X electrode lines X₁ through Xₙ are sustain electrodes, the Y electrode lines Y₁ through Yₙ are scan electrodes, and the address electrode lines A_{R1} through A_{Bm} are address electrodes.

The Y electrode lines Y₁ through Yₙ are the scan electrodes to which a data pulse is applied to select discharge cells that are to be used for forming the image that is to be displayed. The scan electrodes may be sequentially applied to the Y electrode lines Y₁ through Yₙ. The three-electrode surface discharge type plasma display panel 1 is described as one exemplary embodiment of the present invention while the present invention is not limited thereto.

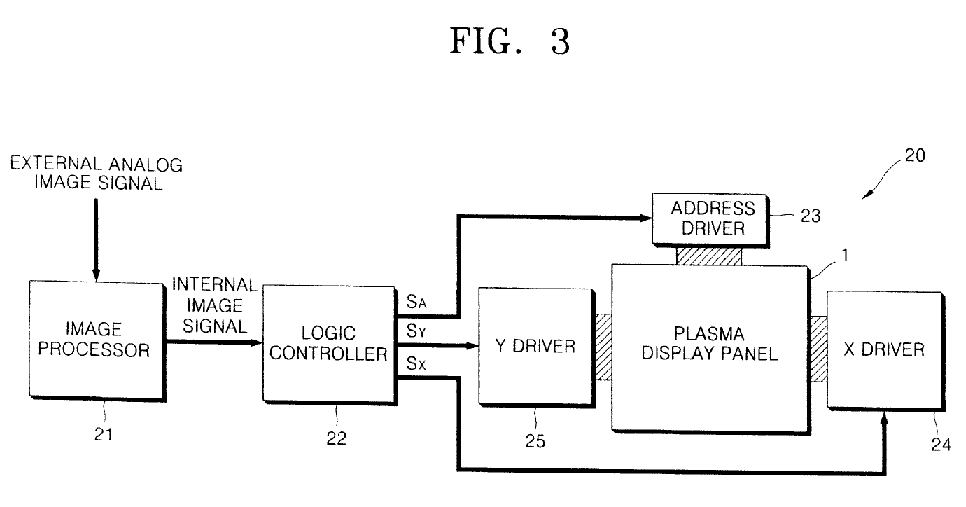

FIG. 3 is a block diagram of a plasma display apparatus 20 according to an embodiment of the present invention.

The plasma display apparatus 20 includes an image processor 21, a logic controller 22, an address driver 23, an X driver 24, a Y driver 25, and a plasma display panel such as the plasma display panel 1 of FIG. 2. The image processor 21 of the plasma display apparatus 20 generates internal image signals by transforming external analog image signals into internal image signals that are digital signals. The internal image signals can include eight bits of red R, green G, or blue B color image data, clock signals, or vertical and horizontal synchronizing signals. The logic controller 22 generates driving control signals S_{A}, S_{Y}, and S_{X} in response to the internal image signals received from the image processor 21.

The address driver 23, the X driver 24, and the Y driver 25 generate driving signals respectively in response to the driving control signals S_{A}, S_{Y}, and S_{X}, received from the logic controller 22, and apply the generated driving signals to the corresponding electrode lines of the plasma display panel 1.

The address driver 23 generates a data pulse in response to the driving control signal S_{A} received from the logic controller 22 and applies the data pulse to the address electrode lines A_{R1} through A_{Bm} of the plasma display panel. The X driver 24 applies the X driving control signal S_{X} received from the logic controller 22 to the X electrode lines X₁ through Xₙ of the plasma display panel after processing the X driving control signal S_{X}. The Y driver 25 applies the Y driving control signal S_{Y} received from the logic controller 22 to the Y electrode lines Y₁ through Yₙ of the plasma display panel after processing the Y driving control signal S_{Y}. As explained above, the three-electrode surface discharge type plasma display panel 1 of FIG. 2 may be used in the plasma display apparatus 20.

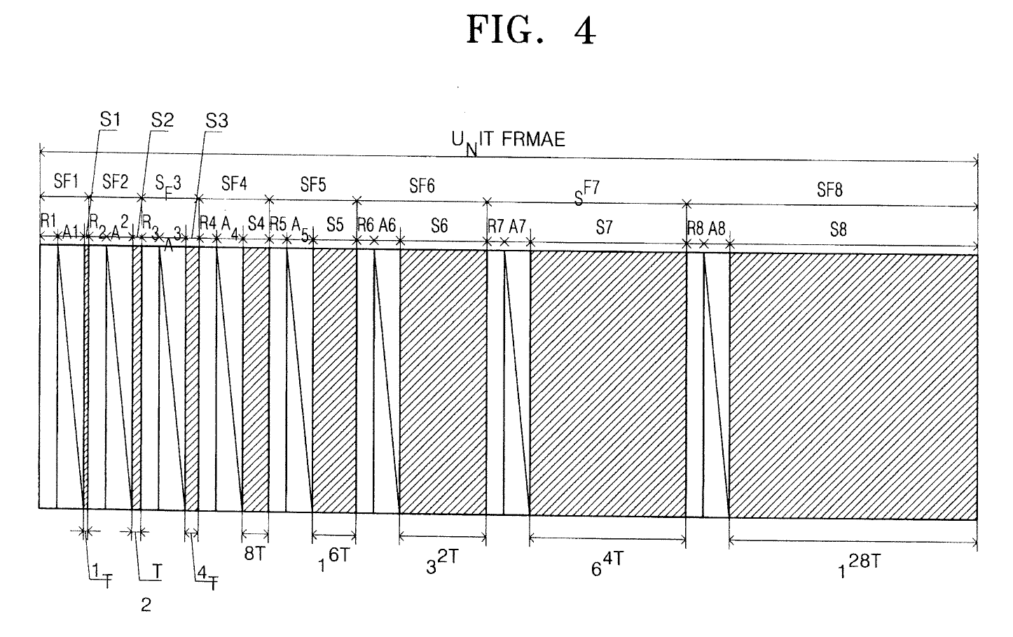

FIG. 4 is a timing diagram illustrating a method of driving a plasma display panel that is driven by dividing a unit frame FR into a plurality of subfields SF1 through SF8, according to an embodiment of the present invention. The driving method of FIG. 4 may be applied for driving the plasma display panel 1 of FIG. 2.

To display a time division grey scale, the unit frame FR is divided into eight subfields SF1 through SF8. Each of the subfields SF1 through SF8 includes a reset period, an address period, and a sustain discharge period. The subfields SF1 through SF8 respectively include reset periods R1 through R8, address periods A1 through A8, and sustain discharge periods S1 through S8.

Brightness of the image generated by the three-electrode surface discharge type plasma display panel 1 is proportional to the length of the sustain discharge periods S1 through S8 during the unit frame FR. The overall length of the sustain discharge periods S1 through S8 in the unit frame FR is 255 T, where T is a time unit. In the exemplary embodiment shown, the duration of each sustain discharge period is set to correspond to 2ⁿ for a sustain discharge period Sn of the nth subfield SFn. Accordingly, including the 0 (zero) grey scale, 256 grey scales can be obtained from an appropriate combination of the eight subfields SF1 through SF8. The 0 (zero) grey scale indicates an absence of discharge in all of the subfields.

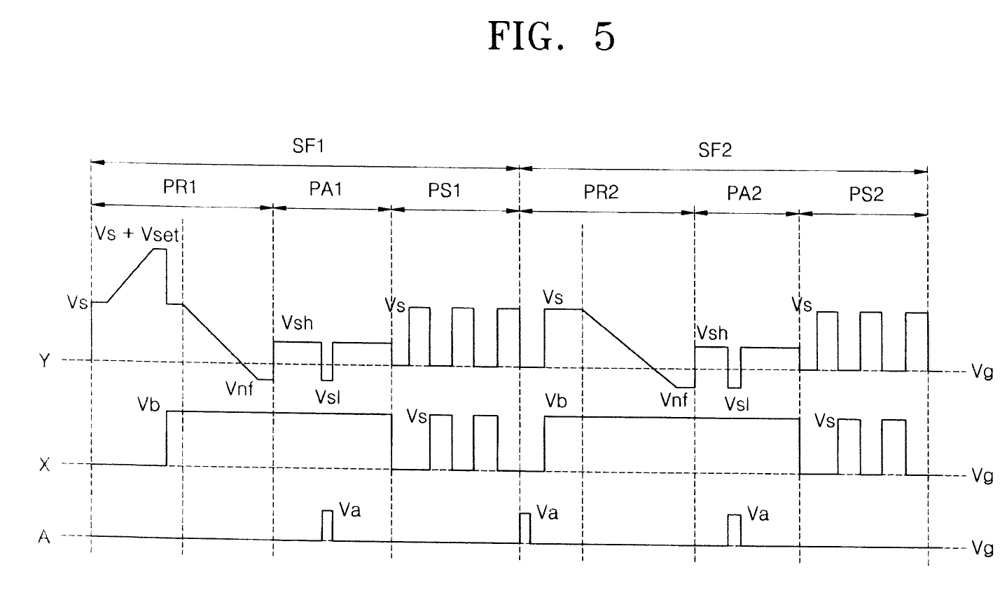

FIG. 5 is the timing diagram of driving signals according to an embodiment of the present invention. The driving signals of FIG. 5 may be output from the address driver 23, the X driver 24, and the Y driver 25 in the plasma display apparatus 20 of FIG. 3 including the three-electrode surface discharge type plasma display panel 1 of FIG. 2. Further, the embodiments of the driving method of the present invention can be applied to various types of plasma display panels including a ring discharge type display panel in which electrodes formed in barrier ribs surround a discharge space or a two-electrode type plasma display panel that includes scan electrodes and address electrodes.

A unit frame for driving the plasma display panel is divided into a plurality of subfields. In FIG. 5, the first subfield SF₁ and the second subfield SF₂ of the plurality of subfields are shown, and each of the subfields is divided into a reset period PR, an address period PA, and a sustain discharge period PS.

The first subfield SF₁ includes a main reset period PR₁, a first address period PA₁, and a first sustain discharge period PS₁. During the main reset period PR₁ all of the discharge cells 14 are initialized. During the first address period PA₁ the discharge cells 14 that are to be used to form the image are selected. During the first sustain discharge period PS₁ the selected discharge cells 14 are sustain discharged to display an image.

During the main reset period PR₁, main reset discharge is performed by applying a main reset pulse having a rising ramp waveform and a falling ramp waveform to the Y electrode lines Y₁ through Yₙ, by applying a bias voltage Vb to the X electrode lines X₁ through Xₙ from the point when the falling ramp waveform voltage is applied to the Y electrode lines Y₁ through Yₙ, and by applying a reference voltage such as a ground voltage Vg or 0V to the address electrode lines A_{R1} through A_{Bm}. The entire discharge cells are initialized by the main reset discharge. In the present embodiment, the reference voltage is the ground voltage Vg.

The main reset pulse that is applied to the Y electrode lines Y₁ through Yₙ gradually rises from the sustain discharge voltage Vs as much as the rising voltage Vset and finally reaches the rising maximum voltage Vset+Vs. The main reset pulse, then, falls back to the sustain discharge voltage Vs and gradually falls from the sustain discharge voltage Vs to the falling minimum voltage Vnf. The main reset pulse has a rising ramp waveform Ramp-up and a falling ramp waveform Ramp-dn. The rising ramp waveform Ramp-up may have a predetermined slope that rises slowly from the sustain discharge voltage Vs to the rising maximum voltage Vset+Vs. The falling ramp waveform Ramp-dn may fall from the sustain discharge voltage Vs to the falling minimum voltage Vnf also according to a predetermined slope.

During the first address period PA₁, address discharge is generated by applying a scan pulse to the Y electrode lines Y₁ through Yₙ, and by applying a data pulse to the address electrode lines A_{R1} through A_{Bm} at the same time when the scan pulse is applied to the Y electrode lines Y₁ through Yₙ. The scan pulse may be applied sequentially to the Y electrode lines Y₁ through Yₙ. The discharge cells 14 in which a sustain discharge is to be generated during the first sustain discharge period PS₁ are selected by the address discharge. The scan pulse is maintained at a scan high voltage Vsh for a certain period of time, and is reduced to a scan low voltage Vsl that has a lower voltage than the scan high voltage Vsh. The scan pulse is applied sequentially to the Y electrode lines Y₁ through Yₙ.

During the first address period PA₁, the data pulse is sequentially applied to the address electrode lines A_{R1} through A_{Bm}. The data pulse is at ground voltage Vg in a state that the scan electrodes, that is the Y electrode lines Y₁ through Yₙ, are biased to the scan high voltage Vsh. The data pulse is at a positive polarity address voltage Va when the scan pulse is at the scan low voltage Vsl. The data pulse is synchronized with the scan pulse and applied to the address electrode lines that correspond to the selected discharge cells to generate address discharge only in those cells. In short, the data pulse rises to the positive polarity address voltage Va at the same time when the scan low voltage Vsl of the scan pulse is applied to the Y electrode lines corresponding to the discharge cells that are being selected by creating an address discharge during the address period PA₁.

During the first sustain discharge period PS₁, a sustain discharge is generated by alternately supplying the sustain pulse to the X electrode lines X₁ through Xₙ and the Y electrode lines Y₁ through Yₙ. Due to the sustain discharge, light is generated during each of the subfields with a brightness corresponding to the allocated grey scale weight value of the subfield. The value of the sustain pulse alternates between the sustain discharge voltage Vs and the ground voltage Vg.

After the realization of the first subfield SF₁ is completed, the second subfield SF₂ begins.

The second subfield SF₂ includes an auxiliary reset period PR₂, a second address period PA₂, and a second sustain discharge period PS₂. During the auxiliary reset period PR₂, the discharge cells 14 selected in the preceding subfield, that is, in the present embodiment, the first subfield SF₁, are initialized.

The operations of the auxiliary reset period PR₂ occur only in the discharge cells 14 selected during the first subfield SF₁. An auxiliary reset pulse having a falling ramp waveform is applied to the Y electrode lines of the discharge cells 14 selected in the first subfield SF₁.

During the auxiliary reset period PR₂, an auxiliary reset pulse that rises from the ground voltage Vg to the sustain discharge voltage Vs and then falls to the falling minimum voltage Vnf is applied to the Y electrode lines Y₁ through Yₙ. The auxiliary reset pulse has a falling ramp waveform that slowly falls from the sustain discharge voltage Vs and reaches the falling minimum voltage Vnf.

Also, during the auxiliary reset period PR₂, a bias voltage Vb is applied to the X electrode lines X₁ through Xₙ when the falling ramp waveform voltage is applied to the Y electrode lines Y₁ through Yₙ.

Also, during the auxiliary reset period PR₂, an erase pulse can be applied to the address electrode lines A_{R1} through A_{Bm}. However, if the erase pulse is applied, a lot of positive polarity wall charges are emitted in the space of the discharge cells 14, and the positive polarity wall charges can cause an address delay in the second address period PA₂ after the auxiliary reset period PR₂. The erase pulse can have a voltage range identical to an address voltage Va applied to the address electrode lines A_{R1} through A_{Bm} to simplify the driving circuit by reducing the number of voltage sources to be fewer. Therefore, during the auxiliary reset period PR₂, the erase pulse having the ground voltage and address voltage may be applied to the address electrode lines A_{R1} through A_{Bm} when the ground voltage Vg is applied to both the X electrode lines X₁ through Xₙ and the Y electrode lines Y₁ through Yₙ.

As described above, auxiliary reset discharge is generated when the auxiliary reset pulse is applied to the Y electrode lines Y₁ through Yₙ, the bias voltage Vb is applied to the X electrode lines X₁ through Xₙ, and the erase pulse is applied to the address electrodes. The auxiliary reset discharge initializes only the discharge cells selected in the preceding subfield.

Conventionally, when the first sustain discharge period of the first subfield is over, negative polarity wall charges are accumulated on the Y electrodes, and positive polarity wall charges are accumulated on the X electrodes and the address electrodes. According to the auxiliary reset discharge in the present embodiment, the positive polarity wall charges accumulated on the address electrodes can be erased by applying an erase pulse to the address electrode lines A_{R1} through A_{Bm}. Accordingly, damage to a phosphor material caused by the positive polarity wall charges accumulated on the address electrode lines A_{R1} through A_{Bm} can be reduced or prevented, latent image effect can be reduced, and the emission of unnecessary light due to the accumulated wall charges can be reduced or prevented.

When the auxiliary reset period PR₂ is over, the operations of the second address period PA₂ and the second sustain discharge period PS₂ are performed in the same manner as the operations of the first address period PA₁ and the first sustain discharge period PS₁.

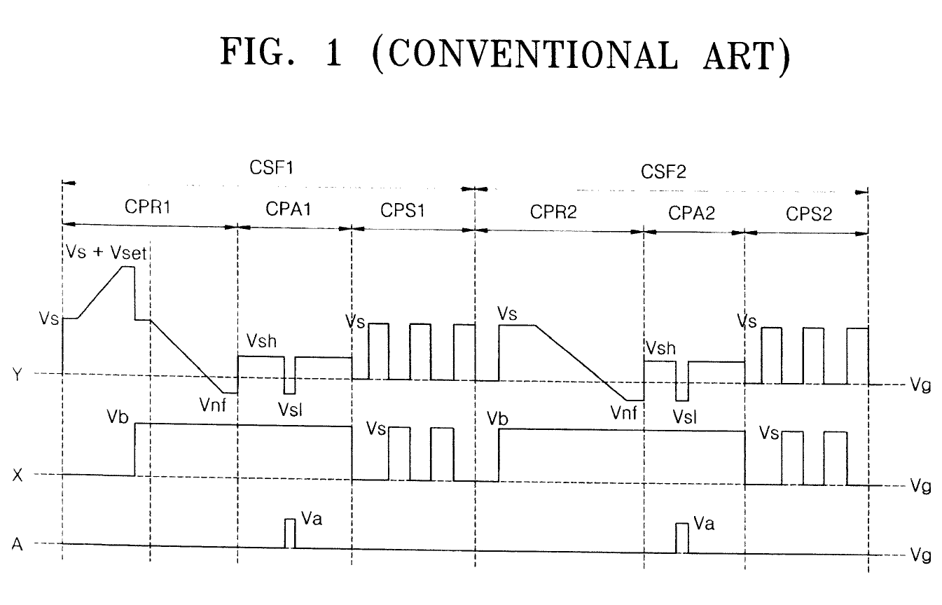

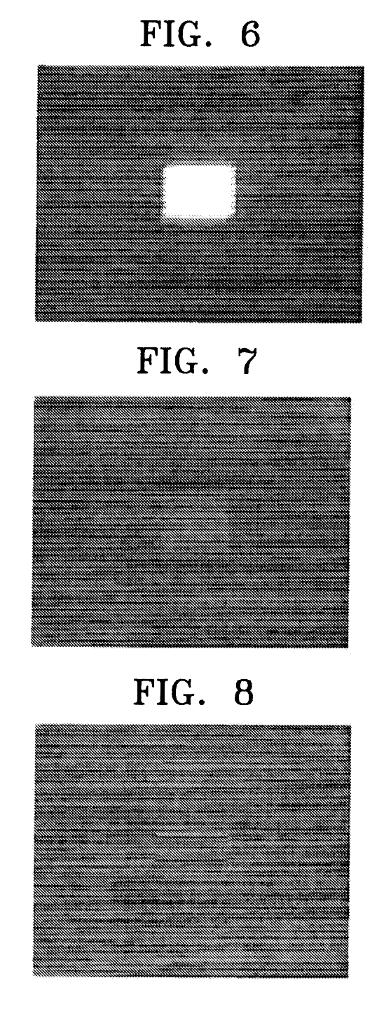

FIG. 6 is a photograph of an initial image generated by a plasma display panel. FIG. 7 is a comparative image of the latent effect that remains after the initial image when the conventional driving waveforms of FIG. 1 are used. FIG. 8 is an experimental image of the latent effect that remains from the initial image when the driving waveforms of FIG. 5 are used.

To evaluate the latent image effect, the plasma display panel was driven so that a central local region of the plasma display panel was to display a fully white image and the surrounding regions were to remain black. The initial image shown in FIG. 6 was generated in this manner. Then, a discharge was generated to display a black image in the entire panel. Last, the latent image remaining on the panel was observed visually. For obtaining the comparative image, after generating the fully white image in the central local region of the plasma display panel, discharge was generated in the entire plasma display panel by applying the driving waveforms in the timing diagram of FIG. 1 to the panel. The latent image remaining when the plasma display panel was driven using the conventional driving method of FIG. 1 is referred to as the comparative image and is shown in FIG. 7. For obtaining the experimental image, discharge was performed in the same manner as for obtaining the comparative image except that the driving signals in the timing diagram of FIG. 5 were applied to the plasma display panel. The latent image remaining when the plasma display panel was driven using the driving method of FIG. 5 is referred to as the experimental image and is shown in FIG. 8. Comparing the images in FIG. 7 and FIG. 8 indicates that the latent image is reduced in FIG. 8 and the image is improved.

As described above, by applying the method of driving a plasma display panel, according to the embodiments of the present invention, wall charges accumulated on the address electrodes of selected discharge cells after a sustain discharge can be effectively erased by applying an erase pulse to the address electrodes. Accordingly, damage to phosphor material due to the wall charges can be reduced or prevented, thereby increasing the lifetime of the plasma display panel.

Also, the erasure of the wall charges accumulated on the address electrodes by applying the erase pulse enables stable reset discharge and reduces the latent image effect. Further, generation of unnecessary emission of light by the wall charges remaining on the address electrodes can be reduced or prevented. Therefore, the method of driving a plasma display panel according to the embodiments of the present invention increases reliability of the plasma display apparatus.

While the present invention has been shown and described with reference to certain exemplary embodiments, it will be understood by one of ordinary skill in the art that various changes in form and details may be made therein without departing from the spirit and scope of the present invention as defined by the following claims and their equivalents.

What is claimed is:

1. A method of driving a plasma display panel, the plasma display panel having discharge cells formed at crossings of address electrodes and sustain electrode pairs, the sustain electrode pairs including X electrodes and Y electrodes being located in parallel, the method comprising:
dividing a unit frame in a display period into a plurality of subfields, each subfield having a grey scale weight value to display a time division grey scale, and each subfield including a reset period, an address period, and a sustain discharge period, the reset period of each subfield being either a main reset period or an auxiliary reset period;
initializing all of the discharge cells during the reset period when the subfield includes the main reset period;
initializing discharge cells selected in a preceding subfield during the reset period when the subfield includes the auxiliary reset period; and
applying an erase pulse to the address electrodes during the auxiliary reset period.

2. The method of claim 1, further comprising:
applying a data pulse to the address electrodes during the address period.

3. The method of claim 2, wherein the erase pulse and the data pulse each include a reference voltage and a first voltage greater than the reference voltage.

4. The method of claim 3, wherein the erase pulse and the data pulse are equal in polarity and magnitude.

5. The method of claim 1, further comprising:
applying a reference voltage to the address electrodes during the main reset period.

6. The method of claim 5,
wherein during the main reset period a main reset pulse is applied to the Y electrodes, and
wherein the main reset pulse rises from a second voltage higher than the reference voltage and later falls to a third voltage is lower than the reference voltage.

7. The method of claim 6, wherein the main reset pulse rises from the second voltage to a fourth voltage higher than the second voltage and falls to the third voltage after the fourth voltage.

8. The method of claim 7, wherein the main reset pulse falls from the fourth voltage to the second voltage before falling to the third voltage.

9. The method of claim 8, further comprising:
applying the reference voltage to the X electrodes during the main reset period while the main reset pulse is at the reference voltage and while the main reset pulse rises from the second voltage to the fourth voltage and falls from the fourth voltage back to the second voltage; and
applying a constant bias voltage higher than the reference voltage to the X electrodes during the main reset period while the main reset pulse falls from the fourth voltage to the second voltage and for a remainder of the main reset period.

10. The method of claim 1,
wherein during the auxiliary reset period an auxiliary reset pulse is applied to the Y electrodes, and
wherein the auxiliary reset pulse rises from a reference voltage to a second voltage higher than the reference voltage and later falls to a third voltage lower than the reference voltage.

11. The method of claim 10, wherein, during the auxiliary reset period, the erase pulse is applied to the address electrodes prior to the auxiliary reset pulse rising from the reference voltage to the second voltage.

12. The method of claim 10, further comprising:
applying the reference voltage to the X electrodes during the auxiliary reset period while the auxiliary reset pulse is at the reference voltage; and
applying a constant bias voltage to the X electrodes during the auxiliary reset period when the auxiliary reset pulse is raised to the second voltage and for a remainder of the auxiliary reset period.

13. A method of enhancing erasure of wall charges remaining after an address discharge on address electrodes of a three-electrode surface discharge type plasma display panel, the plasma display panel including discharge cells formed at crossings of the address electrodes over parallel pairs of sustain electrodes and scan electrodes, the plasma display panel being driven during unit frames, each unit frame being divided into a plurality of subfields, each subfield including a reset period, the address period, and a sustain discharge period, the reset period of each subfield being either a main reset period for resetting all the discharge cells or an auxiliary reset period for resetting a group of discharge cells having undergone the address discharge during the address period of a prior subfield, the method comprising applying an erase pulse to the address electrodes at a beginning of the auxiliary reset period.

14. A plasma display apparatus comprising:
a plasma display panel having a first substrate and a second substrate being separated from and facing each other;
discharge cells being discharge spaces located between the first substrate and the second substrate;
X electrodes and Y electrodes extending in parallel across the discharge cells;
address electrodes extending across the discharge cells crossing a direction of the X electrodes and the Y electrodes at the discharge cells; and
a panel driver that applies driving signals to the X electrodes, the Y electrodes, and the address electrodes,
wherein the driving signals are applied during unit frames, each unit frame being divided into a plurality of subfields for displaying a time division grey scale, each of the subfields including a reset period, an address period, and a sustain discharge period,
wherein the reset period of each of the subfields is either a main reset period for initializing all of the discharge cells or an auxiliary reset period for initializing discharge cells selected during a preceding subfield, and
wherein an erase pulse is applied to the address electrodes during the auxiliary reset period.

15. The plasma display apparatus of claim 14, wherein during the address period of the subfields having an auxiliary reset period, the panel driver applies a data pulse to the address electrodes.

16. The plasma display apparatus of claim 15, wherein the erase pulse and the data pulse each include a reference voltage and a first voltage higher than the reference voltage.

17. The plasma display apparatus of claim 16, wherein the erase pulse and the data pulse are equal.

18. The plasma display apparatus of claim 14, further comprising:
an upper dielectric layer formed over the first substrate; and
a lower dielectric layer formed over the second substrate and over the address electrodes.

19. The plasma display apparatus of claim 18, further comprising:
a passivation layer formed between first substrate and the second substrate.

20. The plasma display apparatus of claim 19, further comprising:
barrier ribs formed over the second substrate, the barrier ribs separating the discharge cells along a direction of the address electrodes; and
phosphor layers formed inside the discharge cells over the barrier ribs.
